(19) United States
(12) Patent Application Publication
(10) Pub. No.: US 2007/0174207 A1
(43) Pub. Date: Jul. 26, 2007

(54) Method and apparatus for information management and collaborative design

(75) Inventors: Paula Kristine Coulman, Austin, TX (US); Benjamin Michael Landman, Pflugerville, TX (US); Ve V. Le, Austin, TX (US); Carlos Raul Salguero, Austin, TX (US); Bruce Irven Waters, Austin, TX (US)

Correspondence Address: MARK P. KAHLER, 8101 VAILVIEW COVE, AUSTIN, TX, 78750, US

(73) Assignee: IBM Corporation, Austin, TX (US)

(21) Appl. No.: 11/340,789

(22) Filed: Jan. 26, 2006

(51) Int. Cl. G06Q 99/00

(52) U.S. Cl. 705/67

(57) ABSTRACT

A method and apparatus are disclosed for managing information in a collaborative design environment. A host zone includes host zone information handling systems (IHSs) that associate with a business entity such as an integrated circuit design and manufacturing house. The host zone IHSs store host zone confidential information. The method and apparatus also employs a partner zone including partner zone IHSs that associate with another business entities or entities, namely partners of the host business entity. A firewall couples the host zone to the partner zone in a manner which controls the flow of information between the host zone and the partner zone. In one embodiment, the disclosed method and apparatus protects personnel using the partner IHSs from exposure to host zone confidential information. In another embodiment, the disclosed technology permits a user of a host zone IHS to access information in the partner zone to assist the partner or partners with the collaborative design project.

### TECHNICAL FIELD OF THE INVENTION

The disclosures herein relate generally to project collaboration systems, and more particularly, to project collaboration systems usable by business partners for design purposes.

### BACKGROUND

Over time the complexity of design projects tends to increase at a dramatic pace in many technologies. For example, in integrated circuit chip design, the required work effort is a monotonically increasing quantity. Integrated circuit design projects are now so complex that it is common to distribute work to many designers at different design locations. Distributing design work in this way may require the sharing of global file systems and data over worldwide geographies. In this manner, design talent at multiple locations becomes available for a chip design project. As business entities begin to partner with one another to share costs and manage staffing, collaboration will likely increase in both quantity and complexity.

This trend places huge demands on data management systems that designers engineered in simpler times for smaller loads. Many business entities, such as corporations, maintain very little access control over their intranets, namely their in-house private computer networks. In many cases all employees of the business entity can access most or all of the data available on the intranet. Some business entities employ global file systems which provide a somewhat more granular control of information access. However, even global file systems tend not fully address secure access to information by business partners. A firewall in the business entity's information system can prevent partner access to global file systems and intranets, but firewalls may not provide access to the data required to collaborate on a project such as chip design.

Information management system architects encounter a number of problems when designing a system that enables a host business entity to share information with a partner business entity. One problem is to expose the data and design automation programs of the host business entity to the partner business entity without providing access to data and programs not required for the particular collaborative design or project. Another problem is to provide for sharing of such data and programs without incurring the full cost of duplicating the entirety of the design automation setup. Design automation setup may include both design automation tools and design databases of the host business entity. These design databases typically include the intellectual property of the host business entity that must not be visible to the partner business entity. Moreover, these design databases may also include the intellectual property of a competitor of the partner business entity that also must not be visible to the partner business entity.

What is needed is a method and apparatus that permits sharing of information between a host business entity and a partner business entity that addresses the information security problems described above.

### SUMMARY

Accordingly, in one embodiment, a collaborative design system is disclosed including a host zone having a plurality of host zone information handling systems (IHSs) that store host zone confidential information. The host zone is associated with a first business entity, such as an integrated circuit design and manufacturing house, for example. The design system also includes a partner zone having a plurality of partner zone IHSs. The partner zone is associated with a second business entity that partners with the first business entity on a design project. The plurality of partner zone IHSs store partner zone confidential information. The design system further includes a firewall, coupling the host zone to the partner zone, that permits an authenticated user of a selected host zone IHS to communicate with a selected partner zone IHS while rejecting attempts of a partner zone IHS to pull information from a host zone IHS.

In another embodiment, a method of collaborating on a design project is disclosed that includes providing a plurality of host zone IHSs and a plurality of partner zone IHSs coupled together by a firewall therebetween. The method includes storing, by the plurality of host zone IHSs, host zone confidential information. The method further includes storing, by the plurality of partner zone IHSs, partner zone confidential information. The method still further includes communicating, by a host zone IHS, through the firewall to a partner zone IHS to obtain partner zone confidential information therefrom to aid a design project in which a host zone business entity and a partner zone business entity jointly collaborate. The method also includes rejecting, by the firewall, an attempt by a partner zone IHS to obtain host zone confidential information from a host zone IHS.

### BRIEF DESCRIPTION OF THE DRAWINGS

The appended drawings illustrate only exemplary embodiments of the invention and therefore do not limit its scope because the inventive concepts lend themselves to other equally effective embodiments.

FIG. 1 shows a block diagram of the disclosed information management and collaborative design system.

FIG. 2 shows a flowchart that depicts operational flow in one embodiment of the disclosed information management and collaborative design system.

FIG. 3 shows a flowchart that depicts operational flow in another embodiment of the disclosed information management and collaborative design system.

FIG. 4 shows a flowchart that depicts operational flow in yet another embodiment of the disclosed information management and collaborative design system.

FIG. 5 shows a flowchart that depicts operational flow in a further embodiment of the disclosed information management and collaborative design system.

FIG. 6 shows a block diagram of a design information handling system in the disclosed information management and collaborative design system.

### DETAILED DESCRIPTION

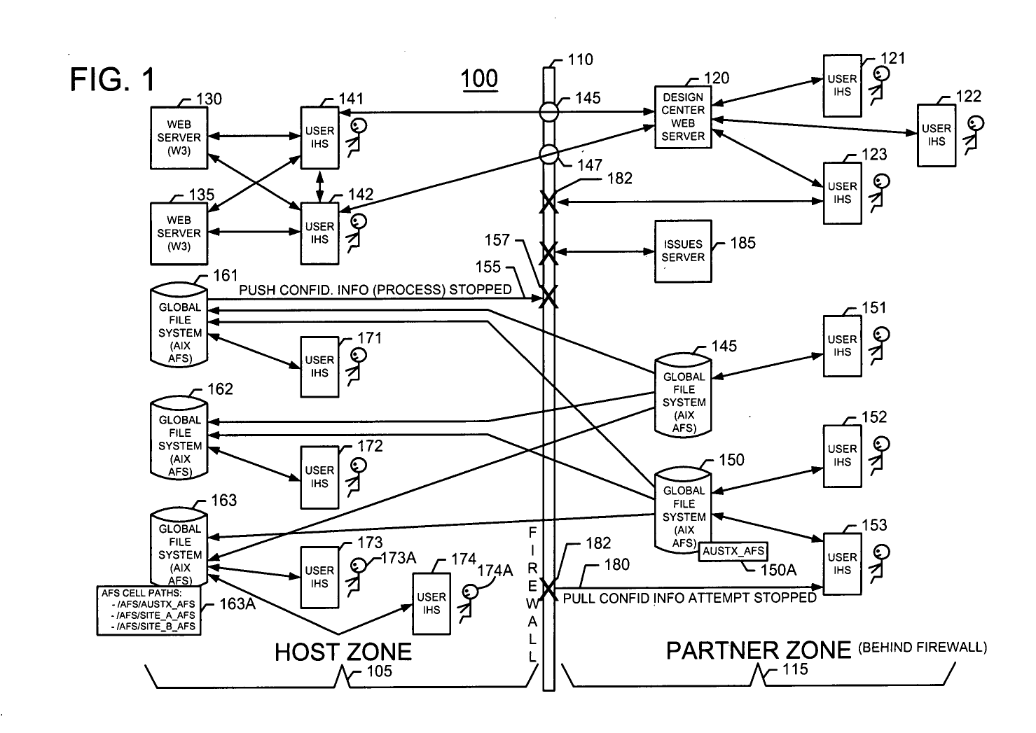

FIG. 1 shows a block diagram of one embodiment of the disclosed information management and collaborative design system 100, hereinafter IM system 100 or simply system 100. IM system 100 includes a host zone 105 of information handling systems (IHSs) and a firewall 110 which selectively couples IHSs in host zone 105 to IHSs within a partner zone 115. As viewed in FIG. 1, IHSs to the left of firewall 110 are host zone IHSs and IHSs to the right of firewall 115 are partner zone IHSs. These IHSs may take the form of a desktop, server, portable, laptop, notebook, terminal or other form factor IHS at which a user may access information. Accessing information may include one or more of viewing information, inputting information, outputting information, transmitting information, receiving information, and manipulating or changing information. The IHSs may take on other form factors as well such as a personal digital assistant (PDA), a portable telephone device, a communication device or other devices that include a processor and memory adapted for communication. Those IHSs within partner zone 115 are behind firewall 110 as described in more detail below.

In the representative embodiment of FIG. 1, host zone 105 already includes resources capable of handling a design project such as integrated circuit design. However, the business entity that owns or operates host zone 105 desires to partner with one or more other business entities to decrease the cycle time required for the design project, to spread risk, or for other business reasons. Host zone 105 includes design automation tools, infrastructure, design documentation already integrated for chip design within the host business entity. However, host zone 105 also includes proprietary materials that the host business entity can not share with a partner in partner zone 115. Host zone 105 may include intellectual property owned by, or licensed to, the host business entity. In one embodiment, system 100 configures host zone 105 with a Common Tools Environment (CTE) as shown in Rodgers, et al. “Infrastructure Requirements for a Large-Scale Multi-Site VLSI Development Project”, IBM J. Res & Dev, Vol. 46, No. 1, January 2002 which is incorporated herein by reference in its entirety.

Partner zone 115 includes a design center web server 120 about which design efforts of both the partner zone 115 and host zone 105 center. System 100 employs an IHS as a design center server 120 that coordinates the collaborative design project between partner zone 15 and host zone 105 as explained in more detail below. With permission, properly authenticated users associated with one or more partner business entities may access design center server 120. Properly authenticated users associated with host zone 105 may also access design center server 120 as part of the collaborative design effort. With permission, properly authenticated users employ respective IHSs to communicate with design center web server 120 and other components of system 100. A partner zone IHS user may present an ID and associated password for authentication purposes to gain access to design center server 120 and other IHSs in partner zone 115. System 100 configures firewall 110 such that IHS users in the partner zone 115 may see design data for the particular project on which they work but not design data for other projects without proper authentication and permission. System 100 further configures firewall 110 such that IHS users in partner zone 115 may access design infrastructure associated with an assigned design project, but not the design data of other projects.

In one embodiment, system 100 protects users of partner IHSs in partner zone 115 from exposure to the proprietary information or intellectual property in host zone 105. In this manner, system 100 defines user IHSs in partner zone as “behind the firewall”. Stated alternatively, firewall 110 protects confidential information in host zone 105 from exposure to IHS users in partner zone 115 except as otherwise disclosed herein. In one embodiment, system 100 does not permit IHS users in partner zone 115 to inadvertently or intentionally see data in host zone 105.

System 100 includes partner IHSs such as partner IHSs 121, 122 and 123. Partner IHSs 121, 122 and 123 couple to design center web server 120 as shown. In this manner, users of partner IHSs 121, 122 and 123 may access design applications and design information on design center web server 120. In actual practice, many more partner IHSs may couple to design center web server 120 than shown. In one embodiment, the user that operates a partner IHS such as 121, 122 and 123 may be an employee of a partner business entity working in the partner business entity or an employee of the host business entity, or a contractor of the partner business entity.

Host zone 105 of system 100 includes host zone web servers 130 and 135 which couple to host zone user IHSs such as 141 and 142. In actual practice, host zone 105 may include many more host user IHSs than shown. With proper credentials, users of host zone user IHSs 141 and 142 may punch-through firewall 110 via firewall holes 145 and 147, respectively, to access data on design center server 120 that is specific to a particular design project on which the host and partners collaborate. The circles in FIG. 1 that represent holes 145 and 147 and the two way arrows through those holes indicate bidirectional information flow. In this manner, host zone IHS users may collaborate with their partners, namely the users of design center web server 120. Holes 145 and 147 provide host zone IHS users 141 and 142 with bidirectional access to design center web server 120. When a user of host zone IHS 141 or 142 punches through firewall 110 with a request for a web page on design center web server 120, design center web server 120 generates a response which punches back through firewall 110 to provide the requesting host zone IHS with a response. In one embodiment, system 100 employs port 80 to punch-through firewall 110. In another embodiment, host zone web servers 130 and 135 store applications and data which system 100 classifies as host confidential or host internal use only. To access information in host zone web servers 130 and 135, users of the host zone IHSs 141 and 142 must provide proper authentication to web servers 130 and 135. For example, users of host zone IHSs 141 and 142 may present proper ID and password.

Partner zone 115 includes global file systems 145 and 150 typically installed on respective storage information handling systems (IHSs). In actual practice, system 100 may employ more global file systems than shown. The Andrew File System (AFS) is an example of one global file that system 100 may employ as global file systems 145 and 150. AFS includes user authentication to assure that only approved users may access particular files in AFS. The article “OPEN AFS Administration Guide—An Overview of AFS Administration”, ©2000, provides more information regarding AFS and is incorporated herein by reference in its entirety.

As seen in FIG. 1, partner zone user IHSs 151, 152 and 153 couple to global file systems 145 and 150. While not specifically illustrated, each partner zone user IHS 151, 152 and 153 may couple to any of the partner zone global file systems such as 145 and 150. The AFS global file system organizes information into cells, such as cell 150A, designated by path /AFS/<CELL> in FIG. 1, wherein CELL is the cell name. For example, global file system 145 may include an AFS cell named AUSTX_AFS for which the path name is /AFS/AUSTX_AFS. In one embodiment, an AFS cell may include a number of servers under common administration that present as a single logic file system. System 100 can serve information in a global information cell such as cell 150A directly to users of partner zone IHSs such as 151, 152 or 153, upon receiving proper authentication from such users. Alternatively, system 100 may serve information in cell 150A to a user of an IHS coupled to design center web server 120 such as a user of partner zone IHS 121, 122 and 123 is such user transmits has proper AFS approval and transmit proper AFS authentication. Partner zone IHSs 121, 122, 123 couple to global file systems 145 and 150, although for simplicity the connection is not explicitly shown. Host zone users of IHSs 141 and 142 may also punch through firewall 110 provided such users have proper AFS approval and transmit proper AFS authentication. In other words, design center web server 120 may receive requested information from global file systems 145, 150 and serve the requested information to partner zone IHSs 121, 122, 123 and host zone user IHSs 141, 142 after web server 120 authenticates the requesting IHS using native AFS authentication. System 100 thus avoids adding another layer of authentication and in doing so promotes efficiency in this embodiment.

In one embodiment, system 100 employs a manual process 155 to decide whether or not to push host proprietary or confidential information from host zone 105 into partner zone 115. In manual process 155, a person indicated by the “X” at 157 acts as a gatekeeper and decides whether a particular piece of host confidential information should go across firewall 110 from host zone 105 to partner zone 115. The “X” at 157 indicates that in this particular example the gatekeeper person decides to not allow transport or pushing of the host confidential information to partner zone 115. In actual practice, upon a request from a person in host zone 105, a team or committee may decide to allow or not allow a piece of host confidential information to move from host zone 105 to partner zone 115.

Host zone 105 includes global file systems 161, 162 and 163 that in one embodiment employ the AFS global file system. Host zone 105 further includes host zone user IHSs 171, 172, 173 and 174 that couple to each of global file systems 161, 162 and 163. To avoid complexity, FIG. 1 does not show all of these possible connections. In actual practice, host zone 105 may include more host zone user IHSs and more host zone global file systems than shown. Global file systems 161, 162 and 163 may include one or more AFS cells at a particular site or location and can access cells at other cites or locations, provided the user has proper authentication. For example purposes, global file system 163 includes paths to /AFS/AUSTX_AFS, namely a cell in partner zone 115 at a particular site. Global file system 163 users may also see paths to cells /AFS/SITE_A_AFS and /AFS/SITE_B_AFS at other sites, namely a location at site A and a location at site B in different geographical regions. FIG. 1 shows these host zone AFS cell paths at 163A.

In system 100, users of partner IHSs in partner zone 115 may see cells in partner zone 115. However, users of these partner IHSs do not see cells in host zone 105. For example, users of partner IHSs in partner zone 115 may see and access cell AUSTX_AFS 150A in partner zone 115 if these users present proper AFS authentication to system 100. However, users of partner IHSs in partner zone 115 do not see host zone cells such as /AFS/SITE_A_AFS and /AFS/SITE_B_AFS shown it 163. In contrast, users of IHSs in host zone 105 may both see and access the AUSTX_AFS cell 150A in partner zone 115, if these users present proper AFS authentication, i.e. appropriate AFS credentials for cells such as AUSTX_AFS in partner zone 115. The arrows drawn from global file systems 145 and 150 in partner zone 115 to global file systems 161, 162, 163 are one way arrows to indicate that firewall 110 permits authenticated users in host zone 105 to see and access cells in global file systems 145 and 150, whereas firewall 110 prevents users in partner zone 115 from seeing or accessing cells associated with global file systems 161, 162, 163 in host zone 105. Two headed arrows indicate bidirectionality or access in both directions.

If a user in partner zone 115 attempts to pull confidential information from host zone 105, as indicated by arrow 180, firewall 110 rejects that attempt as indicated by the “X” 182 at firewall 110. For a user of a host zone IHS 171, 172, 173, 174 to access AFS cells in global file systems 161, 162, 163 the user must present proper AFS credentials to system 100. Firewall 110 also prevents a user of a partner zone IHS 121, 122, 123 that logs onto design center web server 120 from accessing information in host zone 105. FIG. 1 shows an “X” 185 at firewall 110 to indicate that firewall 110 rejects such attempts.

When a user of a host zone IHS 171-174 logs on to the AFS global file system at 161-163 and provide proper AFS authentication for the AUSTX_AFS cell in partner zone 115, then such a user can see and manipulate design project information in AUSTX_AFS. However, this coupling is not bidirectional in the sense that a partner zone IHS 151-153 user can not see or manipulate information on host global file systems 161-163.

In the course of a collaborative design project, problems or issues arise. For example, a tool does not function properly, a macro does not behave in the expected manner or a functional block produces an error. System 100 includes an issues server 185 for tracking the existence and resolution of problems that occur during the design project. For example, users in host zone 105 such as 141, 142, 171-174 perform design work on the project. One of these users discovers a problem and writes it up as an issue. The user then uses his or her AFSTX_AFS ID and password information to log on to AUSTX_AFS and punch through firewall 110 to send the written issue to issues server 185. In actual practice, the user goes through the wall with Secure SHell (SSH) or telnet and logs on to AUSTX_AFS using the appropriate AUSTX_AFS ID and password. Using SSH, the host zone user stores the written issue on issues server 185 which tracks the issue until resolution. This methodology is a form of indirect issue reporting. Users of partner zone IHSs 121-123 and 151-153 may log directly on to issues server 185 using their AUSTX_AFS cell ID and password to directly report an issue to issue server 185. To avoid undue complexity, FIG. 1 does not depict the coupling between issue server 185 and user IHSs 141, 142, 171-174, 121-123 and 151-153.

In one embodiment, design project planners divide a particular project into units. For example, an integrated circuit design project divides into multiple units, wherein each unit typically corresponds to a different functional unit of the integrated circuit. Each unit may correspond to a different worksite that is responsible for that unit. For example, a designer using host user IHS 172 may complete design on a particular functional unit and deliver that unit through firewall 110 for storage on global file system 145. When all functional units are complete and submitted to global file system 145, the users of system 100 integrate all of the units together to complete the total design. Users of host zone IHSs such as 171-174 may contribute to both the logic design and physical design of the integrated circuit design project. In one embodiment, host zone 105 may include a large number of IHS users, for example hundreds or even the thousands of users, who can perform design tasks and send results across firewall 110 to partner IHSs in partner zone 115. In this manner, IHS users in host zone 105 may provide a massive amount of support to partners in partner zone 115 to collaboratively work on a design project.

A host zone IHS that a designer uses is a host zone designer IHS. Similarly, a partner zone IHS that a designer uses is a partner zone designer IHS. The host zone IHS that a design tool owner uses is a design tool owner host zone IHS.

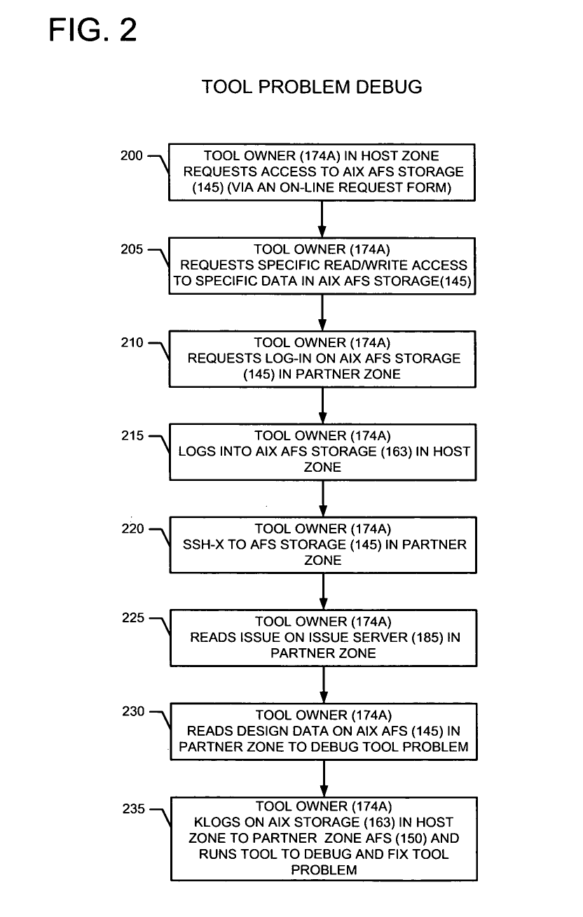

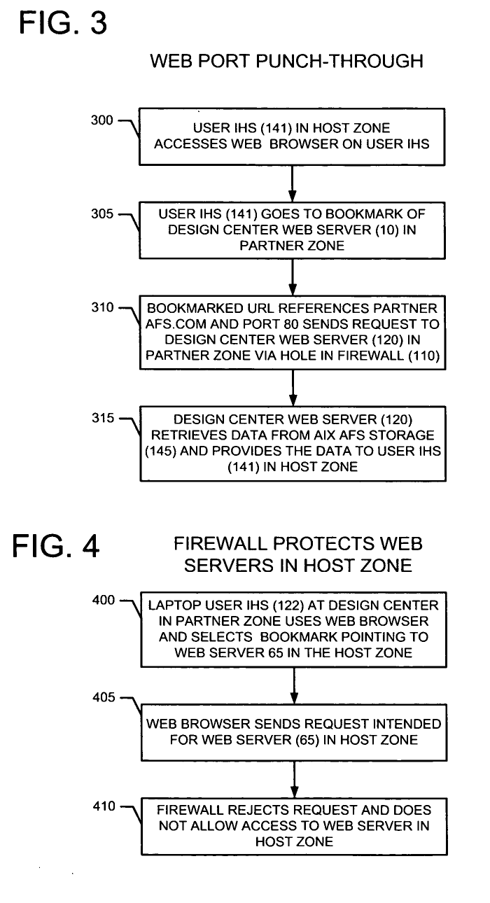

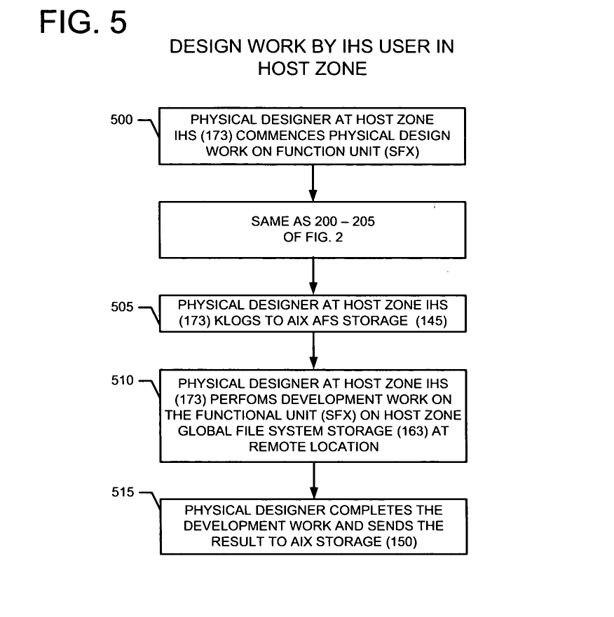

FIG. 2 shows a flowchart that depicts process flow during a tool problem debug operation in system 100. For purposes of system 100, a tool is a software application that assists in the collaborative design effort engaged in by host IHS users and partner IHS users. In this example, the user of IHS 174 is the tool owner 174A. Tool owner 174A in host zone 105 requests access to global file system storage 145 (AIX AFS) via an online request form, as per block 200. Tool owner 174A requests specific read/write access to specific data in global file system 145 as per block 205. The specific data relates to the collaborative project between the host and partners. Then, as per block 210, tool owner 174A requests log-in on global file system 145 (AIX AFS) in the partner zone 115 so he can see information such as current issues. Tool owner 174A in host zone 105 then logs into global file system storage 163 in host zone 115, as per block 215. Then tool owner 174A employs a secure shell program such as SSH to securely access global file system 145, as per block 220. In practice, SSH is a set of programs that replaces telnet, rlogin, rsh and rcp to provide public/private key technology for authenticating and encrypting sessions between user accounts. One the tool owner 174A securely establishes access to global file system 145, then tool owner 174A reads an issue on issue server 185, as per block 225. Although not specifically shown in FIG. 1, issues server 185 couples to global file systems 145 and 150. Tool owner 174A reads design data on global file system 145 in partner zone 230 to debug or fix a tool problem, as per block 230. Then tool owner 174A Klogs on global file system 163 in host zone 105 to cell AUSTX_AFS in partner zone 115. Klog is a command that obtains an AFS token from an authentication server for a specific AFS user ID in a specific AFS cell for use in accessing data. Tool owner 174A runs the subject tool to debug the problem and then ultimately fixes the problem while logged in, all as per block 235.

In more detail, once tool owner 174A logs into global file system 145, the tool owner desires to run a test. In this example, tool owner 174A stores data in global file system 163 that he wants to use for the test. In this manner, tool owner 174A can debug using host zone data rather than partner zone data. Tool owner 174A may debug in host zone global file system 163 by running the selected tool and making a change. Tool owner 174A may maintain or store a test bucket in global file system 163 where the tool owner runs the test. The tool owner may adjust the information in the test bucket to match or correspond to data the tool owner observed in global file system 145 for test purposes. In this particular example, the tool owner 174A determines that he can reproduce a problem that the design center in partner zone 115 is experiencing. Users in partner zone 115 desirably do not have access to the host zone's proprietary test tool which resides in host zone global file system 163. Some tools to which host zone user 174 may have access include logic design tools, tools that compare logic design to the physical design of the subject integrated circuit, preliminary timing tools, placement tools, wiring tools and fine tuning data timing tools, for example.

FIG. 3 shows a flowchart that depicts process flow when system 100 employs web port punch-through to communicate across firewall 110. A user of host zone IHS 141 accesses a web browser on IHS 141, as per block 300. That user then goes to a bookmark of design center web server 120 in partner zone 115, as per block 305. A universal resource locator (URL) associated with that bookmark references web server 120, e.g. DES_CNTR_WEB.AUSTX_AFS.HOST.COM. Port 80 sends a request to design center web server 120 via punch-through hole 145 in firewall 110, as per block 310. In response, design center web server 120 retrieves data from global file system 145 (AIX AFS) and provides requested data to host zone IHS 141, as per block 315.

FIG. 4 shows a flowchart that depicts process flow when firewall 110 protects web server 130 or 135 in host zone 105. In this scenario, a user of a laptop IHS 122 in the host zone design center associated with design center web server 120 uses a web browser and selects a bookmark pointing to web server 130 in host zone 105, as per block 400. The web browser of laptop IHS 122 sends a request intended for web server 135, as per block 405. Firewall 110 then rejects the request and disallows access to web servers in host zone, as per block 410.

FIG. 5 shows a flowchart that shows process flow for design work by an IHS user in the host zone 105 of system 100. A physical designer 173A at one of the host zone IHSs, for example IHS 173, commences physical design work on a functional unit (SFX) of the integrated circuit design. The designer 173A then engages in the same steps 200-225 of the flowchart of FIG. 2. The physical designer at IHS 174 then Klogs to global file system storage 145 to access information stored therein, as per block 505. Then the physical designer at IHS 173 in the host zone performs development work on the functional unit (SFX) on global file system 163, as per block 510. In one embodiment, host zone user IHS 173 may be at a location remote from the location of design center web server 120. The physical designer then completes the development work and sends the result to global file system storage 150 which stores the result for use by partners in partner zone 115, as per block 515. In one embodiment, system 100 periodically shadows design data from global file system 150 to one or more of global file system 161-163. For example, in one embodiment each night host zone global file system 163 accesses design data in the AUSTX_AFS cell 150A of partner zone global file system 150 and stores a copy, namely a shadow, on global file system 163. The user of IHS 173 may access this shadow to aid in design work.

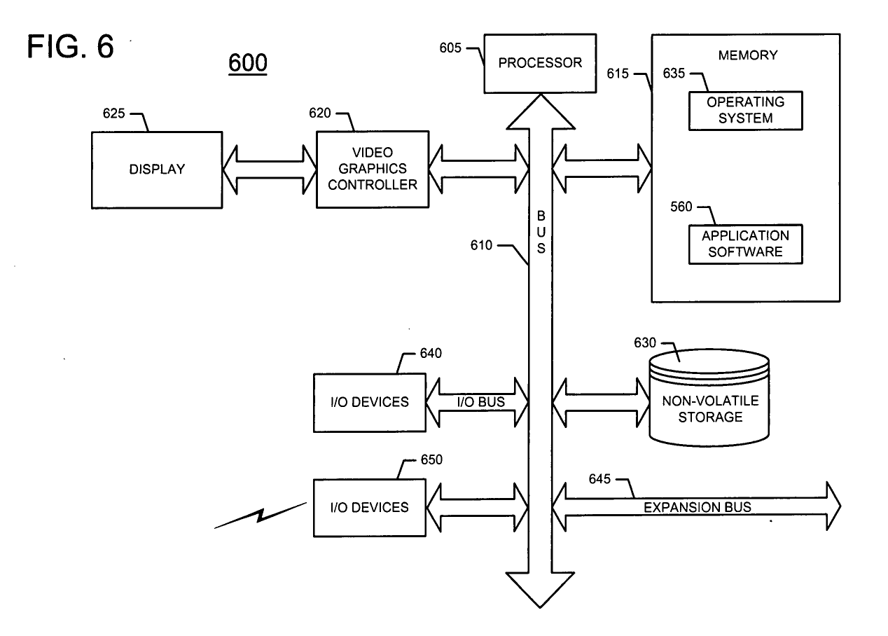

Information handling systems (IHSs) form many of the components and structures of system 100. For example, system 100 employs the following IHSs: design center web server 120, user IHSs, 121-123, web servers 130, 135, user IHSs 141, 142, global file systems 145, 150, user IHSs 151-153, global file systems 161-163, user IHSs 171-174, and issues server 185. Depending of the particular application within system 100, these IHSs may employ some or all of the components of IHS 600 of FIG. 6. IHS 600 includes a processor 605. IHS 600 further includes a bus 610 that couples processor 605 to system memory 615 and video graphics controller 620. A display 625 couples to video graphics controller 620 in one embodiment. Those IHSs for which there is not a regular user may not require a separate display. Nonvolatile storage 630, such as a hard disk drive, CD drive, DVD drive, or other nonvolatile storage couples to bus 610 to provide IHS 600 with permanent storage of information. An operating system 635 loads in memory 615 to govern the operation of IHS 600. I/O devices 640, such as a keyboard and a mouse pointing device, couple to bus 610. One or more expansion busses 645, such as USB, IEEE 1394 bus, ATA, SATA, PCI, PCIE and other busses, couple to bus 610 to facilitate the connection of peripherals and devices to IHS 600. A network adapter 650 couples to bus 610 to enable IHS 600 to connect by wire or wirelessly to a network and other information handling systems. In actual practice, IHS 600 may take many forms. For example, IHS 600 may take the form of a desktop, server, portable, laptop, notebook, or other form factor computer or data processing system. IHS 600 may take other form factors such as a gaming device, a personal digital assistant (PDA), a portable telephone device, a communication device or other devices that include a processor and memory.

The foregoing discloses an information management collaborative design system in which users in a partner zone may collaborate with users in a host zone on a design project. In one embodiment, the system protects users in the partner zone from contamination by confidential information in the host zone.

Modifications and alternative embodiments of this invention will be apparent to those skilled in the art in view of this description of the invention. Accordingly, this description teaches those skilled in the art the manner of carrying out the invention and is intended to be construed as illustrative only. The forms of the invention shown and described constitute the present embodiments. Persons skilled in the art may make various changes in the shape, size and arrangement of parts. For example, persons skilled in the art may substitute equivalent elements for the elements illustrated and described here. Moreover, persons skilled in the art after having the benefit of this description of the invention may use certain features of the invention independently of the use of other features, without departing from the scope of the invention.

What is claimed is:

1. A collaborative design system comprising:
a host zone including a plurality of host zone information handling systems (IHSs) that store host zone confidential information, the host zone being associated with a first business entity;
a partner zone including a plurality of partner zone IHSs, the partner zone being associated with a second business entity that partners with the first business entity in a collaborative design project, the plurality of partner zone IHSs storing partner zone confidential information; and
a firewall, coupling the host zone to the partner zone, that permits an authenticated user of a selected host zone IHS to communicate with a selected partner zone IHS while rejecting attempts by a partner zone IHS to pull information from a host zone IHS.

2. The collaborative design system of claim 1, wherein the plurality of host zone IHSs includes a plurality of host zone global file system IHSs that store design information.

3. The collaborative design system of claim 2, wherein the plurality of host zone IHSs includes a plurality of web servers that store design information.

4. The collaborative design system of claim 3, wherein the plurality of host zone IHSs include a plurality of host zone user IHSs coupled to the a plurality of host zone global file system IHSs and the plurality of web servers that store design information.

5. The collaborative design system of claim 4, wherein the plurality of partner zone IHSs includes a partner zone web server that stores design information.

6. The collaborative design system of claim 5, wherein the plurality of partner zone IHSs includes a plurality of global file systems.

7. The collaborative design system of claim 6, wherein the plurality of partner zone IHSs includes an issues server that stores information regarding design problems encountered in the collaborative design project.

8. The collaborative design system of claim 7, wherein the plurality of partner zone IHSs includes a plurality of partner zone user IHSs coupled to the partner zone web server and the plurality of global file systems.

9. A method of collaborating on a design project comprising:
providing a plurality of host zone IHSs and a plurality of partner zone IHSs coupled together by a firewall therebetween;
storing, by the plurality of host zone IHSs, host zone confidential information;
storing, by the plurality of partner zone IHSs, partner zone confidential information;
communicating, by a host zone IHS, through the firewall to a partner zone IHS to obtain partner zone confidential information therefrom to aid a design project in which a host zone business entity and a partner zone business entity jointly collaborate; and
rejecting, by the firewall, an attempt by a partner zone IHS to obtain host zone confidential information from a host zone IHS.

10. The method of claim 9, further comprising rejecting, by the firewall, an attempt by a host zone IHS to send host zone confidential information to a partner zone IHS.

11. The method of claim 9, wherein the partner zone IHSs include a design web server that stores design information relating to the design project between the host zone and the partner business entity.

12. The method of claim 11, further comprising punching through the firewall, by a host zone IHS, to the design web server to obtain selected design information, the selected design information punching back through the firewall to the host zone IHS.

13. The method of claim 9, wherein the host zone IHSs include a plurality of host zone global file systems, the method further comprising:
storing, by the plurality of host global file systems, the host zone confidential information.

14. The method of claim 13, wherein the partner zone IHSs include a plurality of partner zone global file systems, the method further comprising
storing, by the plurality of partner zone global file systems, the partner zone confidential information.

15. The method of claim 14, further comprising
receiving, by a host zone global file system, instructions from a host zone IHS, to log on to the host zone global file system thus providing a first log on request;
granting, by the host zone global file system, the first log on request if the first log on request includes predetermined first authentication information;
receiving, by a partner zone global file system, instructions from the host zone IHS, to log on to the partner zone global file system thus providing a second log on request;
granting, by the partner zone global file system, the second log on request if the second log on request includes second predetermined information.

16. The method of claim 15, further comprising:
sending, by a design tool owner host zone IHS, the first log on request to the host zone global filing system;
sending, by the design tool owner host zone IHS, the second log on request to the partner zone global file system;
retrieving, by the design tool owner host zone IHS, information related to a design problem from the partner zone global file system;
sending, by the design tool owner host zone IHS, problem solution information to the partner zone global file system.

17. The method of claim 9, wherein the plurality of host zone IHSs includes a host zone web server, the method further comprising:
sending, by a partner zone IHS, a request for host zone confidential information to the host zone web server; and
rejecting, by the firewall, the request for host zone confidential information.

18. The method of claim 9, wherein the plurality of partner zone IHSs includes an issues server, the method further comprising:
sending, by a partner zone IHS, a request for problem information to the issues server; and
sending, by the issues server, the requested problem information to the partner zone IHS.

19. The method of claim 9, wherein the plurality of partner zone IHSs includes an issues server, the method further comprising:
sending, by a host zone IHS, a request for problem information to the issues server; and
sending, by the issues server, the requested problem information to the host zone IHS.

20. A design information handling system (IHS) configured for use in a collaborative design system, the IHS comprising:
a processor
a memory coupled to the processor;
the collaborative design system comprising:
a host zone including a plurality of host zone IHSs that store host zone confidential information, the host zone being associated with a first business entity;
a partner zone including a plurality of partner zone IHSs, the partner zone being associated with a second business entity that partners with the first business entity on a design project, the plurality of partner zone IHSs storing partner zone confidential information; and
a firewall, coupling the host zone to the partner zone, that permits an authenticated user of a host zone IHS to communicate with a selected partner zone IHS while rejecting attempts by a user of a partner zone IHS to pull information from a host zone IHS,
wherein the design IHS is employed as at least one of the plurality of host zone IHSs and at least one of the plurality of partner zone IHSs.
